(19) United States
(12) Patent Application Publication
(10) Pub. No.: US 2026/0336599 A1
(43) Pub. Date: Oct. 29, 2026

(54) VEHICLE BRAKING SYSTEM AND METHOD FOR CONTROLLING A VEHICLE BRAKING SYSTEM

(71) Applicant: Robert Bosch GmbH, Stuttgart (DE)

(72) Inventors: Andreas Englert, Suzhou (CN); Vincent Schertling, Stuttgart (DE)

(21) Appl. No.: 19/631,025

(22) Filed: Mar. 27, 2026

(30) Foreign Application Priority Data
Mar. 31, 2025 (DE) 10 2025 112 448.5

(51) Int. Cl. B60W 30/00; B60W 10/184; B60W 10/22

(52) U.S. Cl. CPC B60W 30/00; B60W 10/184; B60W 10/22; B60W 2510/22; B60W 2710/18; B60W 2710/22

(57) ABSTRACT

A method for controlling a vehicle braking system of a vehicle provided with a level control function during performance of level control of the vehicle in a braked state in which a first braking force is applied to at least one front axle brake and a second braking force is applied to at least one rear axle brake. The method includes: before or during the performance of the level control, performing a level control braking force adjustment in which a braking force at one of the at least one front axle brake and the at least one rear axle brake is reduced to a third braking force; and after completion of the level control, increasing the braking force at the one of the at least one front axle brake and the at least one rear axle brake starting from the third braking force.

### FIELD

The present disclosure relates to a vehicle braking system and to a method for controlling a vehicle braking system.

### BACKGROUND INFORMATION

Modern off-road vehicles or mid-range/luxury-class vehicles can be equipped with a level control system. The aim of this system is to change the vehicle height relative to the wheel-supporting surface (the ground). This can improve off-road capability in off-road vehicles, increase ease of entry in luxury-class vehicles, and reduce the influence of loading/trailer load on the normal vehicle height in mid-range station wagons.

Level control systems often comprise air spring units that are mounted in the suspension in addition to the conventional spring/damper unit. However, there are also systems in which the level-controlling element is housed in the conventional spring/damper unit. Hydropneumatic systems are also possible.

When the level control is used, the distance between the underside of the vehicle and the ground changes, and thus also the distance between the underside of the vehicle and the wheel center. Thus, depending on the direction, the suspension is compressed or extended.

Due to the wheel kinematics of the suspension system, the wheel also experiences a position change not only in the vertical direction, but also in the horizontal plane, i.e., along the ground-contact surface. Depending on the suspension system type, the wheelbase is, for example, smaller when the suspension is fully extended than when it is fully compressed. The same applies to the track width.

These changes in wheelbase and track width, which result from the wheel kinematics during jounce and rebound, can cause various limitations in the comfort behavior of the vehicle when the level control is activated at a standstill.

For example, if an off-road vehicle is on a steep hill (e.g., with a gradient of 20%), a driver must generate high pressure by means of the brake in order to hold the vehicle at a standstill. If the vehicle is to be raised from normal ride height to off-road ride height, all wheels are firmly braked during the raising operation, resulting in stresses in the suspension and brakes.

These stresses can manifest themselves in the following ways:
The brake starts to creak during the raising operation because the braking force is no longer sufficient to absorb the additional forces acting on the stressed suspension.
The suspension could also become noticeable due to noises, since rubber bearings or joints may not be stressed in their intended shape.
Once the raising operation is complete and the driver releases the brake, a noticeable jolt may occur in the vehicle, as the stressed suspension suddenly relaxes due to the (again) freely rolling wheels.
The stressing of the suspension can also lead to a higher load on the compressor or pump of the level control system.

An object of the present disclosure is to provide a solution to the problems outlined above.

### SUMMARY

The object may be achieved in a first aspect by a method for controlling a vehicle braking system, which has at least one front axle brake and at least one rear axle brake, of a vehicle provided with a level control function during performance of level control of the vehicle in a braked state (e.g., at a standstill of the vehicle) in which a first braking force is applied to the at least one front axle brake and a second braking force is applied to the at least one rear axle brake. According to an example embodiment, the method comprises:
before or during the performance of the level control, performing a level control braking force adjustment in which a braking force at one (e.g., only one) of the at least one front axle brake (i.e., the front axle) and the at least one rear axle brake (i.e., the rear axle) is reduced to a third braking force, and
after completion of the level control, increasing the braking force at the one of the at least one front axle brake and the at least one rear axle brake starting from the third braking force.

By reducing the braking force before or during the performance of the level control at the one of the at least one front axle brake and the at least one rear axle brake, it is possible to allow one or more wheels on the relevant axle of the vehicle to roll, thereby solving the problems discussed at the outset. This includes, in particular, a reduction in the impairment of comfort during the performance of the level control and a reduction in the load acting on a level control device providing the level control function during the performance of the level control.

Furthermore, it can be provided that during the level control braking force adjustment, a braking force at the other of the at least one front axle brake and the at least one rear axle brake is increased to a fourth braking force and, after completion of the level control, the braking force at the other of the at least one front axle brake and the at least one rear axle brake is reduced starting from the fourth braking force.

By increasing the braking force at the other of the at least one front axle brake and the at least one rear axle brake, sufficient total braking force can be ensured so that the vehicle can be held at a standstill even during the performance of the level control.

The at least one front axle brake can, for example, comprise a plurality of front axle brakes/front wheel brakes assigned to front wheels provided at the front axle. Analogously, the at least one rear axle brake can comprise a plurality of rear axle brakes/rear wheel brakes assigned to rear wheels provided at the rear axle. For example, during the level control braking force adjustment, the braking force at each front axle brake/front wheel brake can be reduced and the braking force at each rear axle brake/rear wheel brake can be increased. Alternatively, during the level control braking force adjustment, the braking force at each front axle brake/front wheel brake can be increased and the braking force at each rear axle brake/rear wheel brake can be reduced.

The level control braking force adjustment can be performed automatically upon initiation of the level control function, which, on the one hand, leads to greater ease of use, since a driver can perform the level control in a simpler way, and, on the other hand, ensures that the advantages of the present disclosure discussed at the outset can be reliably achieved.

After completion of the level control, the first braking force and the second braking force can be restored; i.e., after completion of the level control, the change in the braking force can be completely reversed.

In order to ensure during the performance of the level control that a sufficient total braking force is always applied, which is sufficient to hold the vehicle at a standstill, it can be provided that, before or during the performance of the level control, the increase in the braking force at the other of the at least one front axle brake and the at least one rear axle brake is performed faster than the reduction in the braking force at the one of the at least one front axle brake and the at least one rear axle brake.

In order to ensure even after completion of the level control that a sufficient total braking force is always applied, which is sufficient to hold the vehicle at a standstill, it can be provided that the increase in the braking force at the one of the at least one front axle brake and the at least one rear axle brake is performed faster than the reduction in the braking force at the other of the at least one front axle brake and the at least one rear axle brake.

In order to ensure during the performance of the level control that one or more wheels at the front axle or rear axle of the vehicle can roll as freely as possible, it can be provided that, before or during the performance of the level control, the braking force at the one of the at least one front axle brake and the at least one rear axle brake is completely decreased, i.e., reduced to zero.

In order to hold the vehicle at a standstill during the performance of the level control, it can further be provided that a resultant total braking force composed of the third and fourth braking forces is greater than or equal to an initial total braking force composed of the first and second braking forces.

The level control braking force adjustment can occur both when the driver holds the vehicle at a standstill with the brake pedal pressed and when an automatic holding function is active. It can be provided that an automatic holding function is activated upon initiation of the level control function.

In a second aspect, a computer program is provided comprising commands that, when the computer program is executed by a computer, cause the computer to carry out a method of the present disclosure described above.

In a third aspect, a computer-readable storage medium is provided on which an above-described computer program is stored. The storage medium can, for example, have a random access memory, read-only memory, a hard disk, etc., or be designed as such.

In a fourth aspect, a vehicle braking system is provided, which has: at least one front axle brake, at least one rear axle brake, and at least one control device configured to perform control according to an above-described method of the present disclosure. The control device can, for example, have a storage medium according to the third aspect and a data processing device, such as a processor, configured to execute a program according to the second aspect. The data processing device, and thus the control device, can therefore be considered a computer within the meaning of the present disclosure.

The at least one control device can be designed as a central control device configured to control both the at least one front axle brake and the at least one rear axle brake. Furthermore, the control device can be configured to also control a level control device of the vehicle that provides the level control function.

In a fifth aspect, a vehicle is provided having an above-described vehicle braking system and a level control device according to the present disclosure.

The present disclosure is explained in more detail below with reference to the figures.

### BRIEF DESCRIPTION OF THE DRAWINGS

FIG. 1 is a schematic representation of a vehicle having a vehicle braking system and a level control device.

FIG. 2 is a schematic representation illustrating a mode of operation of a level control device according to an example embodiment.

FIG. 3 is a schematic representation illustrating a change in wheelbase during the performance of level control, according to an example embodiment.

FIG. 4 is a flow chart of an exemplary method for controlling a vehicle braking system according to the present disclosure.

### DETAILED DESCRIPTION OF EXAMPLE EMBODIMENTS

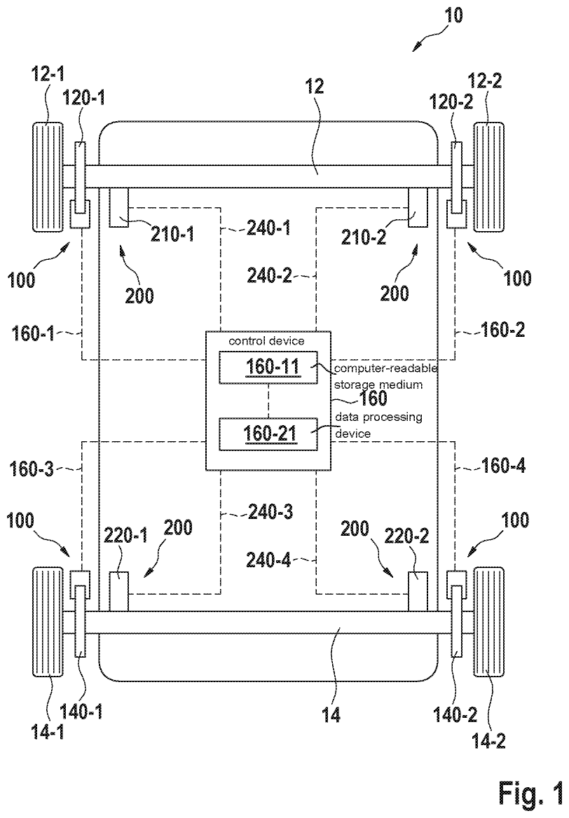

FIG. 1 is a schematic representation of a vehicle 10 having a vehicle braking system 100 and a level control device 200.

The vehicle braking system 100 can have: on a front axle 12 of the vehicle 10, a first front axle brake (front wheel brake) 120-1 assigned to a first front wheel 12-1, and a second front axle brake (front wheel brake) 120-2 assigned to a second front wheel 12-2, and on a rear axle 14 of the vehicle 10, a first rear axle brake (rear wheel brake) 140-1 assigned to a first rear wheel 14-1, and a second rear axle brake (rear wheel brake) 140-2 assigned to a second rear wheel 14-2. The first front axle brake 120-1, the second front axle brake 120-2, the first rear axle brake 140-1, and the second rear axle brake 140-2 can, for example, be designed as hydraulic brakes or as electromechanical brakes.

The vehicle braking system 100 also has a control device 160 configured to individually control the first front wheel brake 120-1, the second front wheel brake 120-2, the first rear wheel brake 140-1, as well as the second rear wheel brake 140-2. The control device 160 can, for example, be in signal exchange connection with the first front axle brake 120-1, the second front axle brake 120-2, the first rear axle brake 140-1, and the second rear axle brake 140-2 in an assigned manner via signal exchange lines 160-1, 160-2, 160-3, 160-4.

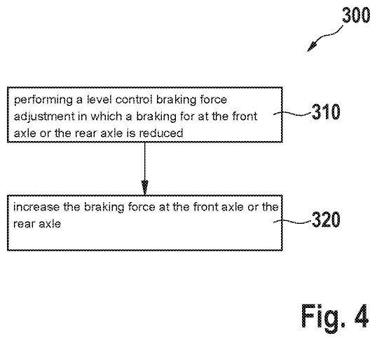

The control device 160 can, for example, have a computer-readable storage medium 160-11 and a data processing device 160-21. On the storage medium 160-11, a computer program can be stored comprising commands that, when executed by the data processing device 160-21, cause the data processing device 160-21 to carry out a method for controlling the vehicle braking system 100, which is described in detail below with reference to the flow chart in FIG. 4.

The storage medium 160-11 can, for example, have a random access memory, read-only memory, a hard disk, etc. The data processing device 160-21 can, for example, have a processor, an application-specific integrated circuit (ASIC), and the like. The data processing device 160-21 and thus the control device 160 can therefore be considered a computer within the meaning of the disclosure.

The level control device 200 can have, at the front axle 12, one or more front axle level control actuators 210-1, 210-2 and, at the rear axle 14, one or more rear axle level control actuators 220-1, 220-2. These can, for example, have air spring units or hydropneumatic units, or be designed as such. The level control actuators can be in signal exchange connection with the control device 160 via assigned control lines 240-1, 240-2, 240-3, 240-4 and can be individually controlled by said control device.

The control device 160 can thus be designed as a central control device configured to control both the individual brakes and the individual level control actuators.

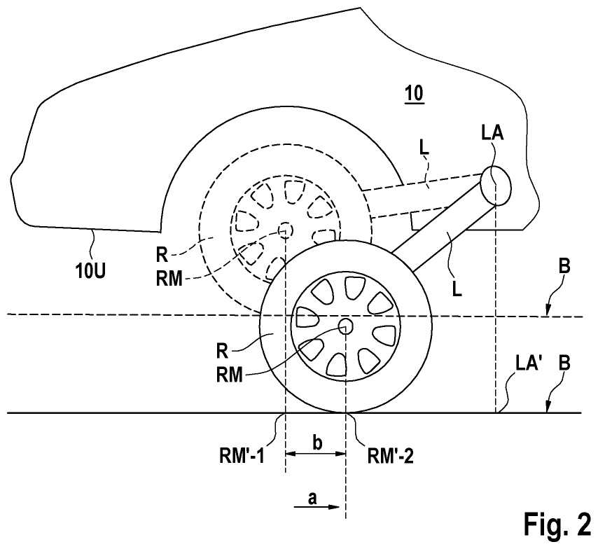

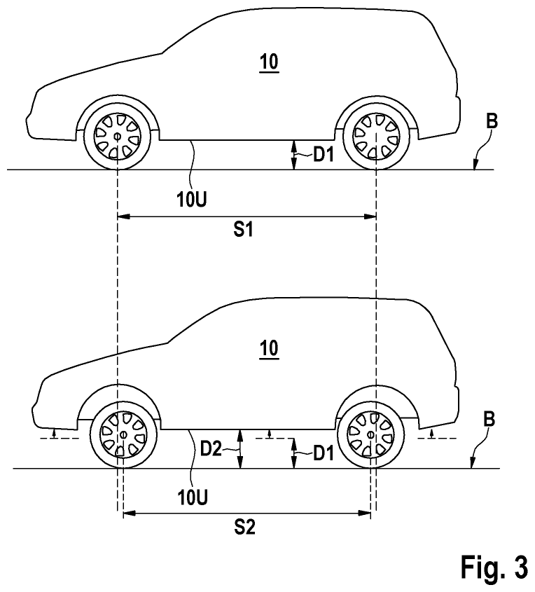

The mode of operation of the level control device 200 is described below with reference to FIGS. 2 and 3. As shown in these figures, by means of the level control device 200, a distance between an underside 10U of the vehicle 10 and a ground-contact surface B can be changed. Such level control devices 200 are used, for example, in off-road vehicles or also in mid-range/luxury-class vehicles.

In off-road vehicles, this can improve off-road capability, in luxury-class vehicles increase ease of entry, and in mid-range station wagons reduce the influence of loading or trailer load on the normal vehicle height.

In the upper representation of FIG. 3, an off-road vehicle is shown by way of example at normal ride height, i.e., in a state in which a first distance D1 is set between the underside 10U of the vehicle 10 and the ground-contact surface B. This ride height can be set, for example, when the vehicle 10 is traveling on a paved roadway. In contrast to this state, the lower representation of FIG. 3 shows the vehicle 10 in an off-road state, in which a second distance D2 is set between the underside 10U of the vehicle 10 and the ground-contact surface B. The second distance D2 is larger than the first distance D1.

By changing the distance between the underside 10U of the vehicle 10 and the ground-contact surface B, the distance between a wheel center RM and the underside 10U of the vehicle 10 also changes, which can be clearly seen in FIG. 2. Due to the kinematics of the suspension system, the wheel R also experiences a position change b along the ground-contact surface B. The direction of the change is indicated by the arrow a in FIG. 2. Depending on the suspension system type, the wheelbase is, for example, smaller when the suspension is fully extended than when it is fully retracted. This is indicated in FIG. 3. Starting from the wheelbase S1 in the upper representation of FIG. 3, the wheelbase is shortened to the wheelbase S2 shown in the lower representation of FIG. 3. The same can apply to the track width.

A shortening of the wheelbase can occur, for example, when a leading arm L, which is shown schematically in FIG. 2, is used. In FIG. 2, the wheel R and the leading arm L are shown in dashed lines before the extension of the suspension and in solid lines after the extension. The projection of the wheel center RM onto the ground-contact surface B in the non-extended state is indicated in FIG. 2 by RM′-1 and in the extended state by RM′-2.

The projection of the leading arm axis LA onto the ground-contact surface B is denoted by LA′. FIG. 2 clearly shows that when a leading arm L is used, the distance between RM′-1 and LA′ before the extension is greater than the distance between RM′-2 and LA′ after the extension. This results in a shortening of wheelbase, clearly visible in FIG. 3, when a leading arm is used.

This change in wheelbase, which results from the wheel kinematics during jounce and rebound, can cause various limitations in the comfort behavior of the vehicle when the level control is activated at a standstill.

For example, if the vehicle 10 is on a steep hill (e.g., with a gradient of 20%), a driver must generate high pressure by means of the brake in order to hold the vehicle 10 at a standstill. If the vehicle is to be raised from normal ride height D1 to off-road ride height D2, all wheels are firmly braked during the raising operation, resulting in stresses in the suspension and brakes.

These stresses can manifest themselves in the following ways:
The brake starts to creak during the raising operation because the braking force is no longer sufficient to absorb the additional forces acting on the stressed suspension.
The suspension could also become noticeable due to noises, since rubber bearings or joints may not be stressed in their intended shape.
Once the raising operation is complete and the driver releases the brake, a noticeable jolt may occur in the vehicle 10, as the stressed suspension suddenly relaxes due to the (again) freely rolling wheels.
The stressing of the suspension can also lead to a higher load on the compressor or pump of the level control device 200.

These problems can be solved by means of a method 300 for controlling the vehicle braking system 100, which is explained in more detail below with reference to the flow chart according to FIG. 4.

The method 300 is performed with the vehicle 10 at a standstill, wherein a first braking force is provided at the front axle 12 by means of the front axle brakes 120-1, 120-2 and a second braking force is provided at the rear axle 14 by means of the rear axle brakes 140-1, 140-2. The method 300 comprises:
before or during the performance of the level control, performing a level control braking force adjustment in which a braking force at one of the front axle 12 and the rear axle 14 is reduced to a third braking force (310), and
after completion of the level control, increasing the braking force at the one of the front axle 12 and the rear axle 14 starting from the third braking force (320).

By reducing the braking force before or during the performance of the level control at the one of the front axle 12 and the rear axle 14, it is possible to allow the wheels on the relevant axle of the vehicle 10 to roll, thereby solving the problems discussed at the outset. This includes, in particular, a reduction in the impairment of comfort during the performance of the level control and a reduction in the load acting on the level control device 200 during the performance of the level control.

Furthermore, it can be provided that during the level control braking force adjustment, a braking force at the other of the front axle 12 and the rear axle 14 is increased to a fourth braking force and, after completion of the level control, the braking force at the other of the front axle 12 and the rear axle 14 is reduced starting from the fourth braking force. If, during the level control braking force adjustment, the braking force is reduced at one axle and increased at another axle, a redistribution of braking force takes place between the two axles.

By increasing the braking force at the other of the front axle 12 and the rear axle 14, sufficient total braking force can be ensured so that the vehicle 10 can be held at a standstill even during the performance of the level control.

For example, during the level control braking force adjustment, the braking force at the first front axle brake 120-1 and the second front axle brake 120-2 can be reduced, and the braking force at the first rear axle brake 140-1 and the second rear axle brake 140-2 can be increased. Alternatively, during the level control braking force adjustment, the braking force at the first front axle brake 120-1 and the second front axle brake 120-2 can be increased, and the braking force at the first rear axle brake 140-1 and the second rear axle brake 140-2 can be reduced.

The level control braking force adjustment can be performed automatically upon initiation of the level control function, which, on the one hand, leads to greater ease of use, since a driver can perform the level control in a simpler way, and, on the other hand, ensures that the advantages of the present disclosure discussed at the outset can be reliably achieved.

After completion of the level control, the first braking force and the second braking force can be restored.

In order to ensure during the performance of the level control that a sufficient total braking force is always applied, which is sufficient to hold the vehicle 10 at a standstill, it can be provided that, before or during the performance of the level control, the increase in the braking force at the other of the front axle 12 and the rear axle 14 is performed faster than the reduction in the braking force at the one of the front axle 12 and the rear axle 14.

In order to ensure even after completion of the level control that a sufficient total braking force is always applied, which is sufficient to hold the vehicle at a standstill, it can be provided that the increase in the braking force at the one of the front axle 12 and the rear axle 14 is performed faster than the reduction in the braking force at the other of the front axle 12 and the rear axle 14.

In order to ensure during the performance of the level control that the wheels 12-1, 12-2 at the front axle 12 or the wheels 14-1, 14-2 at the rear axle 14 of the vehicle 10 can roll as freely as possible, it can be provided that, before or during the performance of the level control, the braking force at the one of the front axle 12 and the rear axle 14 is completely decreased, i.e., reduced to zero.

In order to hold the vehicle 10 at a standstill during the performance of the level control, it can further be provided that a resultant total braking force composed of the third and fourth braking forces is greater than or equal to an initial total braking force composed of the first and second braking forces.

The redistribution of braking force can occur both when the driver holds the vehicle 10 at a standstill with the brake pedal pressed and when an automatic holding function is active. It can be provided that an automatic holding function is activated upon initiation of the level control function.

In detail, the method 300 can be carried out as follows. It is assumed without restriction that the vehicle braking system 100 is a hydraulic braking system.

### 1. Initial Situation

At the start of the method, a driver holds the vehicle 10 at a standstill by actuating a brake pedal on a hill with a gradient of, for example, 20%. Alternatively, the vehicle can be held at a standstill by an automatic holding function. A hydraulic brake pressure of 30 bar is applied at each of the front axle brakes 120-1, 120-2 and the rear axle brakes 140-1, 140-2. From this state, the driver activates the level control function. If the driver holds the vehicle 10 at a standstill by actuating the brake pedal, an automatic holding function can be activated, for example, by activating the level control function.

### 2. Start of Braking Force Redistribution

The vehicle braking system 100 begins to redistribute brake pressure from the front axle 12 to the rear axle 14, with a pressure gradient at the front axle 12 of −60 bar/s and a pressure gradient at the rear axle of +100 bar/s. The higher pressure gradient at the rear axle 14 ensures that during the redistribution operation a total braking force is always applied, which can hold the vehicle 10 at a standstill.

Alternatively, the brake pressure can be redistributed from the rear axle 14 to the front axle 12. The subsequent steps would then be performed in a correspondingly reversed manner with respect to the front axle and the rear axle.

### 3. Maintaining the Redistributed Pressure

As soon as sufficient pressure, i.e., sufficient braking force, has built up at the rear axle 14 to allow the vehicle 10 to continue to be held at a standstill, the current pressure is maintained. For example, the pressure at the front axle can be 0 bar and the pressure at the rear axle can be 80 bar. The pressure at the rear axle 14 is more than twice as high as at the beginning of the brake pressure redistribution operation, since in this state the total braking force is applied by the rear axle brakes 140-1, 140-2.

### 4. Performing the Level Control

In this state, the level control is performed to bring the vehicle 10 to the desired height. Because no brake pressure is applied at the front axle brakes 120-1, 120-2, the front wheels can roll substantially freely during the performance of the level control, thus avoiding the problems discussed at the outset.

### 5. Restoring the Original State

Once the level control is complete, the original state is restored by adjusting the brake pressures at the front axle 12 and the rear axle 14 to the original pressures. The pressure change can take place with a pressure gradient of +100 bar/s at the front axle 12 and with a pressure gradient of −60 bar/s at the rear axle 14. The higher pressure gradient at the front axle 12 ensures that a total braking force is always applied, which can hold the vehicle 10 at a standstill. 6. End of Redistribution

The method is terminated as soon as the initial brake pressures of 30 bar are applied at the front axle 12 and at the rear axle 14.

1-12. (canceled)

13. A method for controlling a vehicle braking system of a vehicle, the vehicle braking system including at least one front axle brake and at least one rear axle brake, the vehicle being provided with a level control function during performance of level control of the vehicle in a braked state in which a first braking force is applied to the at least one front axle brake and a second braking force is applied to the at least one rear axle brake, the method comprising:
before or during the performance of the level control, performing a level control braking force adjustment in which a braking force at one of the at least one front axle brake and the at least one rear axle brake is reduced to a third braking force; and
after completion of the level control, increasing the braking force at the one of the at least one front axle brake and the at least one rear axle brake starting from the third braking force.

14. The method according to claim 13, wherein:
during the level control braking force adjustment, a braking force at the other of the at least one front axle brake and the at least one rear axle brake is increased to a fourth braking force, and
after the completion of the level control, the braking force at the other of the at least one front axle brake and the at least one rear axle brake is reduced starting from the fourth braking force.

15. The method according to claim 14, wherein, before or during the performance of the level control, the increase in the braking force at the other of the at least one front axle brake and the at least one rear axle brake is performed faster than the reduction in the braking force at the one of the at least one front axle brake and the at least one rear axle brake.

16. The method according to claim 14, wherein, after the completion of the level control, the increase in the braking force at the one of the at least one front axle brake and the at least one rear axle brake is performed faster than the reduction in the braking force at the other of the at least one front axle brake and the at least one rear axle brake.

17. The method according to claim 13, wherein, before or during the performance of the level control, the braking force at the one of the at least one front axle brake and the at least one rear axle brake is completely decreased.

18. The method according to claim 14, wherein a resultant total braking force composed of the third braking force and the fourth braking force is greater than or equal to an initial total braking force composed of the first braking force and the second braking force.

19. The method according to claim 13, wherein an automatic holding function is activated upon initiation of the level control function.

20. A non-transitory computer-readable storage medium on which is stored a computer program for controlling a vehicle braking system of a vehicle, the vehicle braking system including at least one front axle brake and at least one rear axle brake, the vehicle being provided with a level control function during performance of level control of the vehicle in a braked state in which a first braking force is applied to the at least one front axle brake and a second braking force is applied to the at least one rear axle brake, the computer program, when executed by a computer, causing the computer to perform steps comprising:
before or during the performance of the level control, performing a level control braking force adjustment in which a braking force at one of the at least one front axle brake and the at least one rear axle brake is reduced to a third braking force; and
after completion of the level control, increasing the braking force at the one of the at least one front axle brake and the at least one rear axle brake starting from the third braking force.

21. A vehicle braking system for a vehicle, comprising:
at least one front axle brake;
at least one rear axle brake; and
at least one control device configured to perform control for a vehicle provided with a level control function during performance of level control of the vehicle in a braked state in which a first braking force is applied to the at least one front axle brake and a second braking force is applied to the at least one rear axle brake, the at least one control device configured to:
before or during the performance of the level control, perform a level control braking force adjustment in which a braking force at one of the at least one front axle brake and the at least one rear axle brake is reduced to a third braking force; and
after completion of the level control, increase the braking force at the one of the at least one front axle brake and the at least one rear axle brake starting from the third braking force.

22. The vehicle braking system according to claim 21, wherein the at least one control device is a central control device configured to control both the at least one front axle brake and the at least one rear axle brake.

23. A vehicle, comprising:
a level control device; and
a vehicle braking system, including:
at least one front axle brake,
at least one rear axle brake, and
at least one control device configured to perform control for the vehicle which is provided with a level control function during performance of level control of the vehicle in a braked state in which a first braking force is applied to the at least one front axle brake and a second braking force is applied to the at least one rear axle brake, the at least one control device configured to:
before or during the performance of the level control, perform a level control braking force adjustment in which a braking force at one of the at least one front axle brake and the at least one rear axle brake is reduced to a third braking force, and
after completion of the level control, increase the braking force at the one of the at least one front axle brake and the at least one rear axle brake starting from the third braking force.
